(19) United States
(12) Patent Application Publication
(10) Pub. No.: US 2010/0147766 A1
(43) Pub. Date: Jun. 17, 2010

(54) SEPARATION PROCESS

(76) Inventors: Preben Nissen, Skaerbaek (DK); Victor Johnson, Phil Campbell, AL (US)

Correspondence Address: CANTOR COLBURN, LLP, 20 Church Street, 22nd Floor, Hartford, CT, 06103, US

(21) Appl. No.: 12/305,529

(22) PCT Filed: Jan. 15, 2008
(86) PCT No.: PCT/SE2008/000032

§ 371 Date: Jan. 26, 2010

(30) Foreign Application Priority Data
Jan. 15, 2007 (SE) 0700104-3

(51) Int. Cl. C02F 11/14

(52) U.S. Cl. 210/660; 210/749; 210/738; 210/208

(57) ABSTRACT

The present invention relates to a process and a system for separation of fluids and solids present in a slurry, wherein at least one additive is added to the slurry, which slurry then is fed into a coiled tubing for mixing of the at least one additive with the slurry to obtain a mixed slurry, and thereafter the mixed slurry is separated into fluids and solids. Further, the present invention relates to a coiled tubing for mixing of at least one additive and a slurry. The present invention is especially useful in separation of slurries, such as biomasses and manure from different animals such as cattle, but is also applicable for other types of slurries.

### TECHNICAL FIELD OF THE INVENTION

The present invention relates to a process and a system for separation of fluids and solids present in a slurry, wherein additive(s) are added to the slurry, which additive(s) are mixed with the slurry in the process. The present invention is especially useful for separation of solids and fluids present in slurries, such as biomasses and manure from different animals such as cattle, but is also applicable for other types of slurries.

### BACKGROUND OF THE INVENTION

Manure handling and disposal is getting more complicated for farmers as there is a tendency for livestock production in fewer and larger farms. This means that the problem of manure and biomass disposal increases with legislations demanding that each farmer should have enough land available for spreading the manure produced on the farm in order to prevent eutrophication and odor. Traditional methods of land application of animal wastes will no longer suffice for many livestock producers, such as pork, beef, poultry and dairy producers. However, the land area required may be reduced if manure separation processes are used to lower the content of phosphorus and nitrogen in the manure or if commercial fertilisers could be produced from the manure.

Also, it is considered that it is organic nitrogen, i.e., nitrogen in organic compounds, that gives rise to the large part of the environmental stress put on the lands in the form of a nitrate release, due to it's slow conversion in the soil. According to scientists and the Danish government about 80% of all organic nitrogen is released in the soil. Thus, it is very important to separate organic nitrogen into the solid fraction, e.g., fiber fraction, of a treated slurry.

Separation of nutrients and odor control are key issues facing many livestock producers today. After separation of manure into a fluid and a solid fraction, the fluid with a lower content of phosphorus and nitrogen may be spread on the lands or be further processed. The solids may be reprocessed to be spread onto the lands or sold as commercial solid fertilizers, or the solids may be used for production of biogas or other value added products.

Current mechanical techniques employed in the agricultural sector to separate the wastes include e.g., screw presses, inclined or static screens, belt presses and centrifuges. Additionally, addition of chemicals in the separation is required to achieve a separation of the nutrients required by many producers due to the legislations within the agribusiness. The processes require then additional steps and/or apparatus to achieve sufficient nutrient separation and dewatering to meet legislation or regulatory requirements.

Today, different processes, see for example EP 1 598 329, are used to separate fiber containing slurries, such as manure and biomasses. Some processes use additives to extract components, such as nutrients. However, these processes include admixing of the additives using a mechanical stirrer, which is not possible to use for all types of manure. Problems with these processes will occur if the manure to be separated has a high solids content, like for manure from cattle. Due to the composition and high solids content of cattle manure and other waste streams, the stirring will be inefficient using a mechanical stirrer, and hence the added additives will not be distributed in the manure, i.e., there is simply not enough liquids to help evenly distribute the additives. This process will ameliorate or solve the treatment issues associated with high solids waste streams.

Today the most common way to handle manure from cattle is to apply it onto the lands as it is, untreated, due to the difficulties of treating and separating cattle manure.

However, one process used for cattle manure simply involves no additives for extracting nutrients, wherein the manure is only dewatered in a separation process.

If chemical treatment is required before dewatering, then for admixing additives into manure having a high solids content, the manure needs to be diluted, e.g., with manure with lower solids content, water or recirculated fluids from the separation process to follow.

Also, these processes are all performed in systems with open vessels or some parts of the systems expose the treated material or manure to the surroundings creating an undesirable working atmosphere.

Problems with the processes known today are that not all types of manure/biomass can be separated with extraction of some components/nutrients from the material, as it is, i.e., without further processing of the manure. Material with high solids content is either diluted or lacks extraction of components/nutrients for the separation. Also, the use of open vessels or parts of the systems results in an undesirable working environment due to the nasty-smelling materials to be treated.

### SUMMARY OF THE INVENTION

The present invention refers, in one aspect, to a process for separation of fluids and solids present in a slurry, wherein at least one additive is added to the slurry, which slurry then is fed into a coiled tubing for mixing of the at least one additive with the slurry to obtain a mixed slurry, and thereafter the mixed slurry is separated into fluids and solids. For the mixing, the slurry is pushed upwards in the coiled tubing and the slurry falls downwards in the coiled tubing when the slurry reaches beyond a top of the coiled tubing.

The present invention solves the problems discussed above, and is cost effective. It allows the user to remove only the necessary components/nutrients from the slurry, thereby maximizing efficiency and limiting costs.

The present invention also solves the problem with separation of solids and fluids from different types of slurries. The present invention is useful for separation of solids and fluids present in slurries, e.g., fiber containing slurries. The present invention is useful not only for slurries, such as biomasses and manure from cattle or any other animal, but is also applicable for other types of slurries from e.g., industrial waste waters or sludges like from the sugar industry, paper industry, etc. or municipal waste waters or sludges. The present invention is applicable for slurries with any solids content, and is not to be to construed as limited to slurries with high solids content. The inventive process can also be used for slurries containing any waste which includes oils, fat or greases.

The present invention refers, in a further aspect, to a system for separation of fluids and solids present in a slurry, which system comprises with reference to the accompanying drawing:

at least one device (2) for transporting the slurry through the system,

a device for addition of at least one additive (3 and/or 6),

a coiled tubing (7) for mixing of the at least one additive with the slurry to obtain a mixed slurry, and

a separation device (8) for separating the mixed slurry into fluids and solids.

The coiled tubing is arranged to enable the slurry to be pushed upwards in the coiled tubing and to enable the slurry to fall downwards in the coiled tubing when the slurry reaches beyond a top of the coiled tubing.

The present invention uses mechanical separation and chemical additives to concentrate the desired components/nutrients in the fiber or solid fraction after dewatering.

All apparatuses used in the system according to the invention are sealed creating a closed process, which greatly reduces or eliminates the undesirable working environment.

The term “sealed” used herein in connection with the closed process or system is meant to be interpreted as the process or system contains essentially no open vessels and no open conveying areas providing a more desirable working environment.

The use of the specific mixing unit according to the invention solves the problems with insufficient mixing and chemically treating slurries with high solids content and eliminates the need for dilution of such slurries to be subject to separation.

The present invention refers, in a yet further aspect, to a coiled tubing (7) for mixing of at least one additive and a slurry, which coiled tubing has an inner diameter of at least 40 mm.

The process can be controlled to suit the needs of the individual producer, and makes it possible to recover up to about 99% of the phosphorus and at least about 20% of the nitrogen, contained originally in the slurry, in the solid fraction of separated manure slurry.

The unit may also be mobile, and can be shared by farmers, and may be moved from farm to farm if needed.

### BRIEF DESCRIPTION OF THE DRAWINGS

FIG. 1 shows a schematic drawing of one embodiment of the system according to present invention.

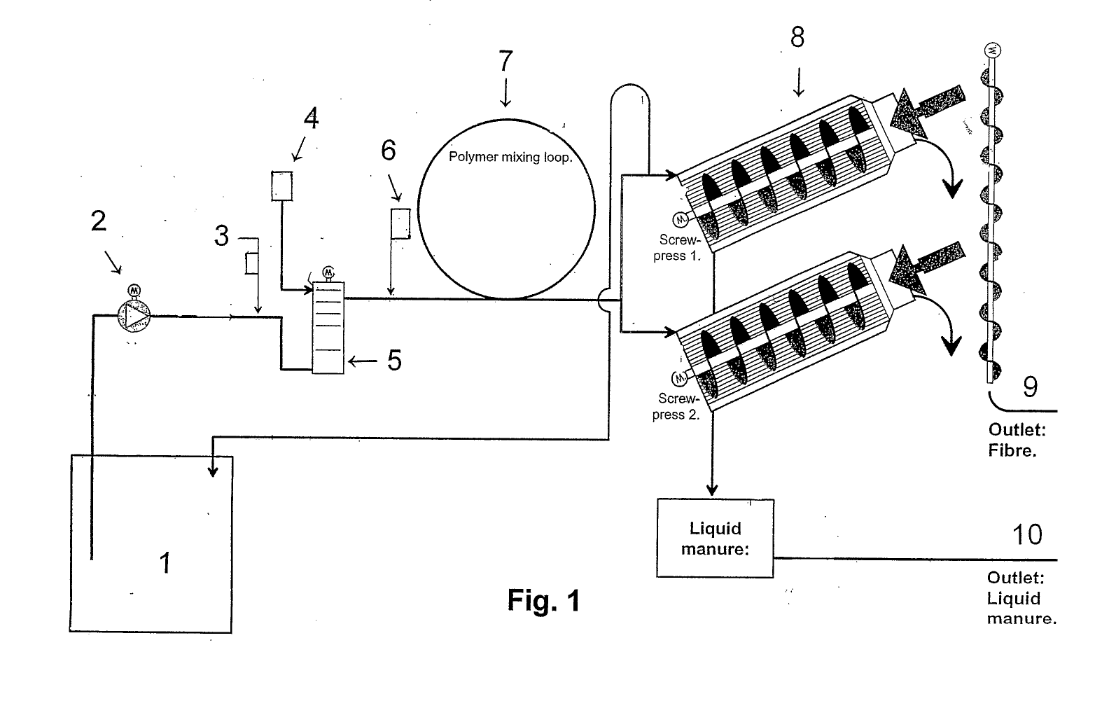

FIG. 2 shows a drawing of one embodiment of the system according to the present invention.

FIG. 3 shows a drawing of one embodiment of the system according to the present invention.

### DETAILED DESCRIPTION OF PREFERRED EMBODIMENTS

The present invention provides a process and a system for separation of fluids and solids present in a slurry, wherein at least one additive is admixed with the slurry before the slurry is separated into fluids and solids.

The process according to the invention allows separation to occur in one closed, integrated process. The users may then utilize the resulting solid and liquid fractions more efficiently.

The process according to the invention concerns separation by mechanical and chemical means.

When precipitating agents are used they cause dissolved compounds to fall out as other insoluble compounds. Some agents cause precipitation of compounds that at the same time are forming flocs that bind together the precipitated compounds and other suspended solids in the water (coagulation). Therefore they might also be called coagulants. However, the definition of coagulation and flocculation is not clear, it varies from different authors. Coagulation may be defined as the process of reducing the electric repulsion between particles by addition of simple salts which then aggregate, or the process whereby charged particles are neutralised. Flocculation may on the other hand be defined as the process of aggregating particles with the aid of polymers, or the process whereby the neutralised/destabilised particles join together and form aggregates, or as a generic term to cover all aggregation processes. Thus, it is realized that it is difficult to properly define the additives used with one general defining term.

Precipitating agents and coagulants like iron and/or aluminum compounds, capable of reacting with the slurry, e.g., manure or biomass, will assist in this process. Materials comprising positive ions with high valence are commonly used as coagulants preferred. Preferably trivalent or multivalent salts are used, such as ferric (Fe(III)) and aluminum salts, and also as polymerised salts. Specific examples include Al₂(SO₄)₃ and iron as either Fe₂(SO₄)₃, FeSO₄ or FeCl₃. can also be used, on condition that it will be oxidised to Fe³⁺ during aeration. Preferably, Fe₂(SO₄)₃ or FeCl₃ are used, especially for manure/biomass separation. Coagulation is dependent on the doses of coagulants, the pH, and colloid concentrations. To adjust pH levels Ca(OH)₂ can be used as a co-flocculent. Amounts of coagualant can vary widely, for example for manure treatment Fe³⁺ is added in an amount of between 0.1 to 1.6 kg Fe³⁺/ton manure slurry, preferably 0.2 to 0.8 kg Fe³⁺/ton manure slurry. Different organic and inorganic coagulants may be used, as well as combinations thereof.

Also materials like bentonite and cerolite could be used.

Flocculants, for example certain polymers, capable of flocculating the slurry might be incorporated into present process. Cationic, anionic, amphiphilic, or nonionic polymers can be used. The most preferred polymers are cationic polyacrylamides, especially for manure/biomass separation. Examples of suitable polymers are cationic polyacrylamides, that can be co-polymers of acrylamide and cationic monomer like acryloyloxyethyltrimethylammonium chloride, methacryloyloxyethyltrimethylammonium chloride, dimethylaminopropylacrylamide, methacrylamidopropylacrylamide, diallyldimethylammonium chloride or made by structural modification of polyacrylamide. In some embodiments, polyamines, polydiallyl dimethyl ammonium chloride, polyethylene imines and/or dicyandiamide polymers are used. The anionic polymers can be for example anionic acrylamide-copolymer like acrylamide-sodiumacrylate-copolymer or anionic acrylamide derivative like hydrolyzed acrylamide-homopolymer. The amount of polymeric flocculant will depend on the type of polymer, molecular weight, charge density, and the material to be treated. Such amounts can be readily determined by one of ordinary skill in the art without undue experimentation. For example in manure treatment a polymer is added in an amount of 0.02 to 0.7 kg active polymer per ton manure slurry, preferably 0.04 to 0.4 kg active polymer per ton manure slurry. The flocculant is preferably applied in the form of emulsion at treatment of manure but a solution can also be used.

Also, acids and bases may be used as pH regulating aids to adjust the pH to a proper range within which the precipitating agents, coagulants and flocculants are active. All additive(s) added in the process according to the invention should be interpreted as necessary added components and should not be interpreted as diluting the slurry.

If necessary, the process can also be aerated, at different points of the system, to ensure better mixing.

In an embodiment of the invention air is introduced before and/or in the coiled tubing.

As used herein, the term “manure” refers to animal excreta collected from stables and barnyards with or without litter. The excreta could be from any animal such as, but not limited to, cattle, cows, swine, pigs, and fowl.

As used herein, the term “biomass” refers to materials coming from living matter, e.g., plant materials like wood, straw, vegetation, agricultural waste, and animal waste, like offalls.

In a preferred embodiment, the invention refers to treatment and separation of manure and/or biomass slurry, especially manure from cattle. The process according to the invention enables extraction of nutrients in the slurry to be recovered in the solid fraction after the separation, based on farmers' and producers' needs.

The process according to the invention may obtain up to about 99% of the phosphorus and at least about 20% of the nitrogen, contained originally in the manure or biomass slurry, in the solid fraction. For example, preferably about 30-99% and most preferably about 50-90% of the phosphorus contained in the manure and/or biomass slurry originally is recovered in the solid fraction. For example about, 20-40%, 20-70% or 20-90% of the nitrogen contained in the manure and/or biomass slurry originally is recovered in the solid fraction. The amounts recovered depends, e.g., on the composition of the slurry material going into the process and the additives used in the process as well as the producers needs.

The system according to present invention for separation of fluids, shown as stream (10), and solids, shown as stream (9), in a slurry from vessel (1), comprises at least one device for transporting the slurry through the system (2), a device for addition of at least one additive (3 and/or 6), a coiled tubing (7) for mixing of the at the least one additive with the slurry, and a separation device (8) for separating the mixed slurry into fluids and solids. In an embodiment of the invention the present system may also contain a pre-mixing apparatus (5) for admixing at least one additive with the slurry, and a device (4) for introduction of air before and/or in the coiled tubing.

The slurry is continuously fed into the separation system, e.g., with a pump.

Then additives, which are able to react with the slurry, are added directly into the slurry stream or admixed in a mixing apparatus.

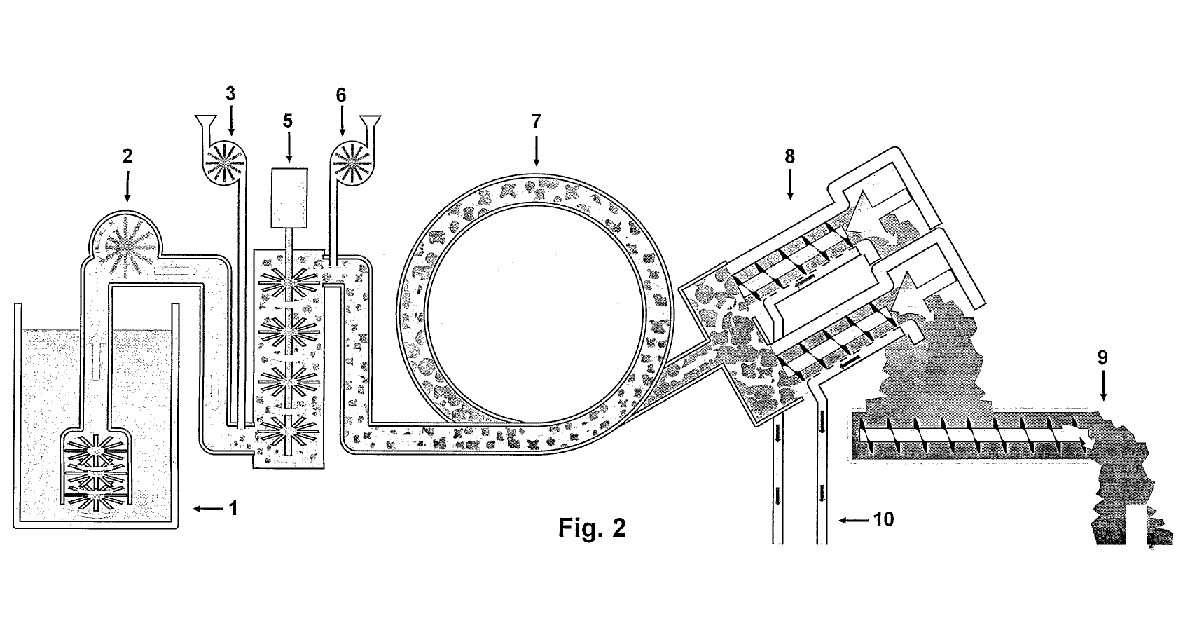

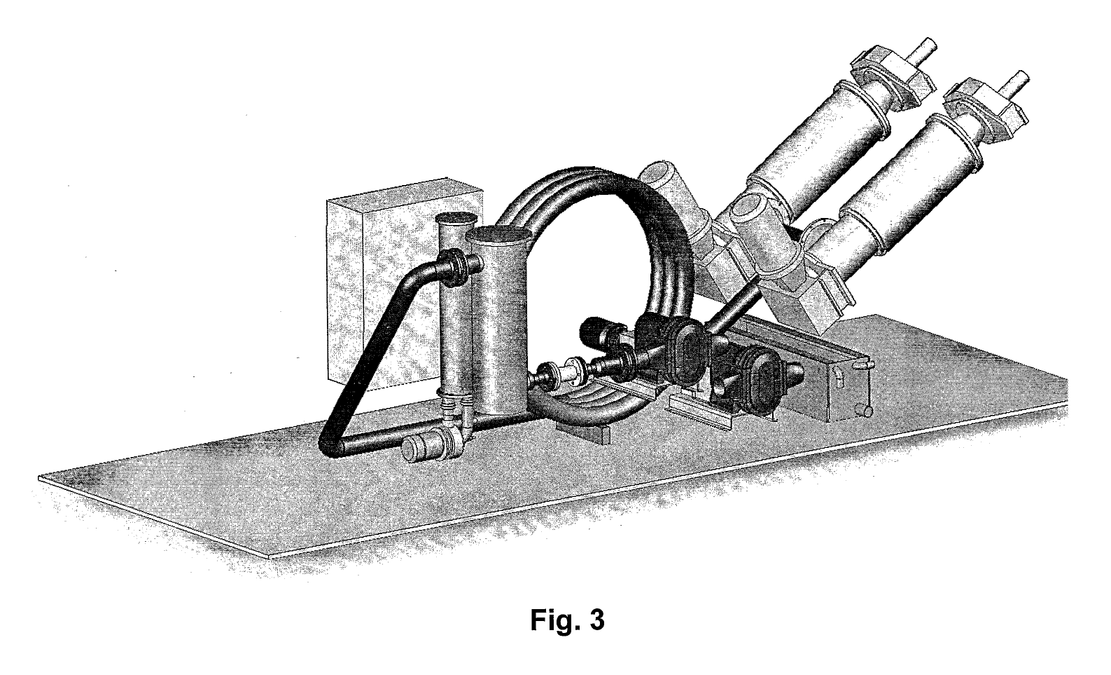

Thereafter, the added compounds are mixed with the slurry in a coiled tubing, e.g., pipe shaped like a loop or helix, preferably with at least one loop. The diameter of the loop or helix is above 500 mm with no above limitation of the diameter of the loop. However, in some systems for some processes the coiled tubing may not need to be a complete loop but part of a loop, e.g., three-quarters of a loop. The coiled tubing is essentially circular in shape, but minor deviations on the appearance and construction of the tubing may occur, as long as the mixing effect of the tubing remains. For example, the coiled tubing might have bends, dents or bulges without deviating from the present invention. If more than a part of a loop or one loop is used, the interconnecting loops may not be totally identical. Some deviations as stated above may occur. The coiled tubing is oriented so that its center line essentially is horizontally disposed. The center line is the imaginary line located in the center of the imaginary cylinder shaped by a helix of the coiled tubing. If the coiled tubing is a loop or a part of a loop the center line is found by considering the loop or part of a loop as a part of a helix. Minor deviations on the orientation of the coiled tubing may occur, as long as the mixing effect of the tubing remains. Illustrations of the orientation of the coiled tubing are found in FIGS. 2 and 3. The inner diameter of the tubing for enclosure of the slurry is preferably at least 40 mm, more preferably at least 50 mm, more preferably at least 75 mm, e.g., 300 mm or higher. Without being bound by theory, mixing of the components is considered to occur by turbulent flow in the loops. Turbulent flow is produced by air contained in the system. The slurry is pushed upwards in the loop by a pump and air passes through the slurry. When the slurry reaches beyond the top of the loop a part of the slurry may due to gravity fall downwards in the loop creating a turbulent flow and by this distributing the additives throughout the slurry. This thorough and yet efficient mixing contributes to improved distribution of the agents, which then are capable of optimum action. The amount of loops (i.e., their length and/or number) depends on the difficulty to evenly distribute the additives into the slurry. After this mixing the slurry is fed into a separation apparatus, e.g., a dewatering device. In an embodiment, the separation of the process of the invention is made by use of at least one screw press, rotary screen, centrifuge, inclined or static screens, chamber filter press, belt press and/or band filter press. The choice of separation depends on the particular application. During this step the slurry may be split into fluid and solids. The fluid and solids may then be further processed.

If the slurry is derived from manure and/or biomass the solids, comprising fibers, are almost odor-free and may be transported from the separation system to a container or storage yard. The solids may be reprocessed to be spread onto the lands or sold as commercial solid fertilizers, or the solids may be used for production of biogas. The solids produced by the present invention are especially suited for production of biogas. Due to the process of the invention the content of carbon in the solids is higher compared to other processes, resulting in a higher biogas yield. The fluid, or reject, from the manure and/or biomass slurry, which is essentially free from particles that may sediment later may be transported to a container. The fluid with a lower content of phosphorus and nitrogen may be spread onto the lands as fertilizer or be further processed.

The system may be made out of metal, polymers or composite material. The system may e.g., be made of polyethylene, stainless steel, and particularly stressed parts may be made of or coated with composite materials.

In a preferred embodiment, the system is a closed system, which is a tremendous improvement compared to the systems using additives that are used today, which are performed in open tanks or batches, creating an undesirable working environment due to the nasty-smelling materials to be treated, i.e., manure/biomass.

In another embodiment, the process of the invention is run at overpressure, i.e., above atmospheric pressure.

The system may also be computerized, i.e., be connected to a computer, which could control the entire process and also report any failure or malfunction in the process or system.

### Examples

Tests have been made on separation of manure from cattle. Tests have been made on both the process according to the invention and a comparative process.

The process according to the invention involved addition of a precipitating agent, Kemwater PIX 115 (a ferric sulfate, Fe content 13 wt. %), and a polymer, (Cytec C-2260, a cationic polyacrylamide, total solids content 50-54%) mixing in a looped pipe with 2 loops, and separation using 1 screw press. The inside diameter of the pipe was 100 mm and the diameters of the loops were 1500 mm.

The comparative process was only separation or dewatering using 1 screw press, as it is a process that is used today.

The tests according to the invention were performed on manure from two different stocks of dairy cows, in Denmark, in the following manner:

Fresh cow manure was continuously pumped through the separation system at a rate of 4 tons/hour (4,000 kg/h). Additives were added at a rate of 12 kg PIX 115 and 0.8 kg polymer emulsion (the polymer emulsion was mixed with 120 l water) per hour. The manure and additives were mixed in a looped pipe with two loops. The process was run over a period of 6 hours, during which 6 samples were taken out for analysis. These samples were then combined and analysed, resulting in mean values for nitrogen, N, phosphorus, P, and the total solids content, TS, which are presented below. The TS content was measured by analysis after drying 24 h in 105° C. The results of the tests are shown in Tables 1 and 2.

Results of the Separation of Manure from Cattle
Process According to the Invention with Additives

TABLE 1
Mass balance and result of analyses

| | Amount | | Total N | N as | |
|---|---|---|---|---|---|
| Type | (kg) | TS (wt. %) | (kg) | Organic N (kg) | P (kg) |
| Manure | 1000 | 7 | 3.5 | 1.7 | 0.5 |
| Water for | 30 | | | | |
| polymer | | | | | |
| Reject | 833 | 1.0 | 1.7 | 0.2 | 0.05 |
| (fluids) | | | | | |
| Fiber | 197 | 31.1 | 1.8 | 1.5 | 0.45 |
| (solids) | | | | | |

From table 1 it can be seen that 51.4% of total N, 88.2% of organic N and 90% of P is recovered in the solids or fiber fraction.

TABLE 2
Mass balance and result of analyses

| | Amount | | Total N | N as | |
|---|---|---|---|---|---|
| Type | (kg) | TS (wt. %) | (kg) | Organic N (kg) | P (kg) |
| Manure | 1000 | 8.5 | 3.9 | 2.0 | 1.2 |
| Water for | 30 | | | | |
| polymer | | | | | |
| Reject | 841 | 1.5 | 1.7 | 0.3 | 0.1 |
| (fluids) | | | | | |
| Fiber | 189 | 34.1 | 2.0 | 1.7 | 1.1 |
| (solids) | | | | | |

From table 2 it can be seen that 51.2% of total N, 85% of organic N and 91.6% of P is recovered in the solids.

Comparative Process with Only Screw Press

TABLE 3
Mass balance and result of analyses

| | Amount | | Total N | N as | |
|---|---|---|---|---|---|
| Type | (kg) | TS (wt. %) | (kg) | Organic N (kg) | P (kg) |
| Manure | 1000 | 7 | 4.0 | 2.0 | 0.7 |
| Reject | 933 | 5.3 | 3.5 | 1.7 | 0.5 |
| (fluids) | | | | | |
| Fiber | 66 | 30.1 | 0.5 | 0.3 | 0.2 |
| (solids) | | | | | |

From table 3 it can be seen that only 12.5% of total N, 15% of organic N and 28.6% of P are recovered in the solids.

By using the process and system according to the invention it is clearly shown that the separation of both nutrients and solids content is considerably increased.

As is apparent from the tables 1-3 above, there is a considerable increase of nutrients, i.e., nitrogen and phosphorus, in the solids, i.e., the fiber fraction, when the process according to the invention is used.

Also, since it is organic nitrogen, i.e., nitrogen in organic compounds, that is a source for the environmental stress put on the lands, it preferably is recovered in the solids. As is shown in Tables 1-3 a considerably larger part of the organic nitrogen is recovered in the solids when the process and system according to the invention is used.

The singular forms “a,” “an,” and “the” include plural referents unless the context clearly dictates otherwise. The endpoints of all ranges reciting the same characteristic or amount are independently combinable and inclusive of the recited endpoint. All references are incorporated herein by reference.

1. A process for separation of fluids and solids present in a slurry, wherein at least one additive is added to the slurry, which slurry then is fed into a coiled tubing for mixing of the at least one additive with the slurry to obtain a mixed slurry, wherein the slurry is pushed upwards in the coiled tubing and the slurry falls downwards in the coiled tubing when the slurry reaches beyond a top of the coiled tubing, and thereafter the mixed slurry is separated into fluids and solids.

2. The process according to claim 1, wherein the coiled tubing used is a pipe essentially shaped like a loop or a helix.

3. The process according to claim 1, wherein the coiled tubing is shaped with at least one loop.

4. The process according to claim 1, wherein the separation is made by use of at least one screw press, rotary screen, inclined or static screens, centrifuge, chamber filter press, belt press and/or band filter press.

5. The process according to claim 1, wherein the at least one additive used is chosen from different organic and inorganic coagulants, precipitating agents, flocculants and/or pH regulating aids.

6. The process according to claim 5, wherein the precipitating agents and/or coagulants are chosen from metal salts and/or polymerised metal salts.

7. The process according to claim 5, wherein the precipitating agents and/or coagulants are chosen from iron and/or aluminum salts.

8. The process according to claim 5, wherein the flocculants are chosen from cationic, anionic and nonionic polymers.

9. The process according to claim 1, wherein the slurry contains fibers.

10. The process according to claim 1, wherein the slurry comprises biomass and/or manure.

11. The process according to claim 1, wherein air is introduced before and/or in the coiled tubing.

12. The process according to claim 1, wherein the process is a closed process.

13. The process according to claim 1, wherein the process is run at overpressure.

14. The process according to claim 10, wherein phosphorus and nitrogen in the slurry are recovered in the solids after the separation process.

15. The process according to claim 14, wherein up to about 99%, of the phosphorus and at least about 20% of the nitrogen are recovered in the solids.

16. A system for separation of fluids and solids present in a slurry, which system comprises:
at least one device (2) for transporting the slurry through the system,
a device for addition of at least one additive (3 and/or 6),
a coiled tubing (7) for mixing of the at least one additive with the slurry to obtain a mixed slurry, wherein the coiled tubing is arranged to enable the slurry to be pushed upwards in the coiled tubing and to enable the slurry to fall downwards in the coiled tubing when the slurry reaches beyond a top of the coiled tubing, and
a separation device (8) for separating the mixed slurry into fluids and solids.

17. The system according to claim 16, which system further comprises at least one of the following:
a pre-mixing apparatus (5) for mixing at least one additive with the slurry, and
a device for introduction of air (4) before and/or in the coiled tubing.

18. The system according to claim 16 or 17, wherein the coiled tubing (7) has an inner diameter of at least 40 mm.
